(19) United States
(12) Patent Application Publication
(10) Pub. No.: US 2019/0320074 A1
(43) Pub. Date: Oct. 17, 2019

(54) Ringtone Setting Method, Electronic Device, and Storage Medium

(71) Applicant: Huawei Technologies Co., Ltd., Shenzhen (CN)

(72) Inventor: Xiaobo Zhang, Shanghai (CN)

(21) Appl. No.: 16/086,255

(22) PCT Filed: Mar. 22, 2016
(86) PCT No.: PCT/CN2016/076992

§ 371 Date: Sep. 18, 2018

(51) Int. Cl. H04M 19/04; H04M 1/725; G10L 25/51

(52) U.S. Cl. CPC H04M 19/04; G10L 25/51; H04M 1/72569

(57) ABSTRACT

Embodiments of the present invention disclose a ringtone setting method, an electronic device, and a storage medium. The method is applied to the electronic device, and the method includes: obtaining, by the electronic device, an identity of the electronic device; obtaining, by the electronic device, a target matching number according to the identity; and determining, by the electronic device, a ringtone corresponding to the target matching number, and setting the ringtone corresponding to the target matching number as a ringtone of the electronic device. A probability that electronic devices of a same model use a same ringtone can be lowered by implementing the embodiments of the present invention.

### TECHNICAL FIELD

The present invention relates to the field of computer technologies, and in particular, to a ringtone setting method, an electronic device, and a storage medium.

### BACKGROUND

The development of electronic technologies has resulted in a growing popularity of mobile phones. People can use a mobile phone for shopping, playing a game, reading an ebook, and the like. Mobile phones may be considered an integral part of people's life, work, and study. A most important function of a mobile phone is making and receiving calls. In most cases, a ringtone used by a user is a default ringtone preconfigured before a mobile phone is delivered. Default ringtones of mobile phones of a same model are usually the same. Therefore, when several users using mobile phones of a same model are in a same environment and a call happens to come in, each user takes the call as his or hers, and the situation is embarrassing. That is, a same default ringtone for mobile phones of a same model puts users to inconvenience.

### SUMMARY

Embodiments of the present invention disclose a ringtone setting method, an electronic device, and a storage medium, to lower a probability that electronic devices of a same model use a same ringtone.

According to a first aspect, an embodiment of the present invention discloses a ringtone setting method, where the method includes:

obtaining, by an electronic device, an identity of the electronic device; obtaining, by the electronic device, a target matching number according to the identity; and determining, by the electronic device, a ringtone corresponding to the target matching number, and setting the ringtone corresponding to the target matching number as a ringtone of the electronic device. Optionally, the electronic device finds, from a preset correspondence between a matching number and a ringtone, the ringtone corresponding to the target matching number, where the correspondence includes multiple ringtones, and the matching number may be known as an identifier, a serial number, or the like in an actual application. Preferably, the correspondence between a matching number and a ringtone is a one-to-one correspondence, but a solution in which multiple target matching numbers are corresponding to one ringtone is not excluded. Further, in an optional solution, after setting the ringtone, the electronic device may further detect whether the electronic device is connected to a network. If the electronic device is connected to the network, the electronic device may further send its identity (for example, an IMEI) to a preset server on which many ringtones are stored. The server may allocate different ringtones to electronic devices according to identities of the electronic devices, and push the allocated ringtones to the corresponding electronic devices, so that the electronic devices set the ringtones as new ringtones. Optionally, after setting the ringtone, the electronic device may further detect whether there is another electronic device using the same ringtone as the electronic device in a surrounding environment. If there is another electronic device using the same ringtone as the electronic device, the electronic device automatically changes the ringtone. For example, a ringtone instruction may be agreed upon in advance for electronic devices of a same model. The ringtone instruction is used to obtain ringtone information. An electronic device that receives the ringtone instruction sends its ringtone information to an electronic device that sends the ringtone instruction. In this way, the electronic device that sends the ringtone instruction can know whether there is another electronic device around using a same ringtone as the electronic device that sends the ringtone instruction.

By performing the foregoing steps, the electronic device selects, based on its identity, a ringtone from multiple pre-stored ringtones as the ringtone. This lowers a probability that the electronic device and another electronic device of a same model use the same ringtone.

With reference to the first aspect, in a first possible implementation of the first aspect, the obtaining, by the electronic device, a target matching number according to the identity includes:

dividing a value corresponding to the identity by a quantity of ringtone files, and using a generated remainder as the target matching number.

With reference to the first aspect, in a second possible implementation of the first aspect, the obtaining, by the electronic device, a target matching number according to the identity includes:

using a value formed by preset M digits in a value corresponding to the identity as the target matching number; or

adding up preset N digits in a value corresponding to the identity to obtain the target matching number, where M is a positive integer greater than or equal to 1, and N is a positive integer greater than or equal to 2.

With reference to any one of the first aspect, the first possible implementation of the first aspect, or the second possible implementation of the first aspect, in a third possible implementation of the first aspect, after the determining, by the electronic device, a ringtone corresponding to the target matching number, and setting the ringtone corresponding to the target matching number as a ringtone of the electronic device, the method further includes:

detecting, by the electronic device, a ringtone in a surrounding environment, and determining whether the detected ringtone is the same as the ringtone of the electronic device;

and if the detected ringtone is the same as the ringtone of the electronic device, changing, by the electronic device, the ringtone of the electronic device.

By performing the foregoing steps, after the electronic device sets the ringtone, if it is detected that there is another electronic device using the ringtone in the surrounding environment, the electronic device changes its ringtone, to avoid user confusion caused by using the same ringtone as the another electronic device.

According to a second aspect, an embodiment of the present invention provides an electronic device, where the electronic device includes a memory and a processor; the memory is configured to store an instruction; and the processor invokes the instruction stored in the memory to perform the following operations:

obtaining an identity of the electronic device;

obtaining a target matching number according to the identity; and

determining a ringtone corresponding to the target matching number, and setting the ringtone corresponding to the target matching number as a ringtone of the electronic device.

The processor invokes the instruction stored in the memory to implement the solutions in the method design of the first aspect. Repetition is omitted herein.

In some possible implementations of the first aspect, or in some possible implementations of the second aspect, the identity includes at least one of the following: an international mobile equipment identity IMEI, a mobile equipment identifier MEID, a phone number, or a first startup time.

According to a third aspect, an embodiment of the present invention provides an electronic device, where the electronic device includes functional units configured to execute some or all steps of any implementation of the first aspect in the embodiments of the present invention. Based on a same invention concept, a principle of resolving a problem by the electronic device is corresponding to the solutions in the method design of the first aspect. Therefore, for implementation of the electronic device, reference may be made to implementation of the method, and repetition is omitted herein.

According to a fourth aspect, an embodiment of the present invention provides a computer readable storage medium, where the computer readable storage medium stores one or more computer programs, and an electronic device executes the ringtone setting method in the first aspect by running the one or more computer programs. Repetition is omitted herein.

By implementing the embodiments of the present invention, the electronic device selects, based on its identity, a ringtone from multiple pre-stored ringtones as the ringtone. This lowers the probability that the electronic device and another electronic device of the same model use the same ringtone.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show some embodiments of the present invention, and a person of ordinary skill in the art may still derive other drawings from these accompanying drawings without creative efforts.

FIG. 1 is a schematic flowchart of a ringtone setting method disclosed in an embodiment of the present invention;

FIG. 2 is a schematic structural diagram of a terminal disclosed in an embodiment of the present invention;

FIG. 3 is a schematic structural diagram of a mobile phone disclosed in an embodiment of the present invention; and

FIG. 4 is a schematic structural diagram of another terminal disclosed in an embodiment of the present invention.

### DESCRIPTION OF EMBODIMENTS

The following clearly and completely describes the technical solutions in the embodiments of the present invention with reference to the accompanying drawings in the embodiments of the present invention. An electronic device described in the embodiments of the present invention may be a mobile phone, a tablet computer, a notebook computer, a palmtop computer, a mobile Internet device (MID, mobile internet device), a wearable device (for example, a smartwatch (such as iWatch), a smart band, or a pedometer), or another terminal device. A ringtone of the electronic device may be defined by a user, or may be defined by a system. When the ringtone is defined by the system, the technical solutions of the present invention are executed.

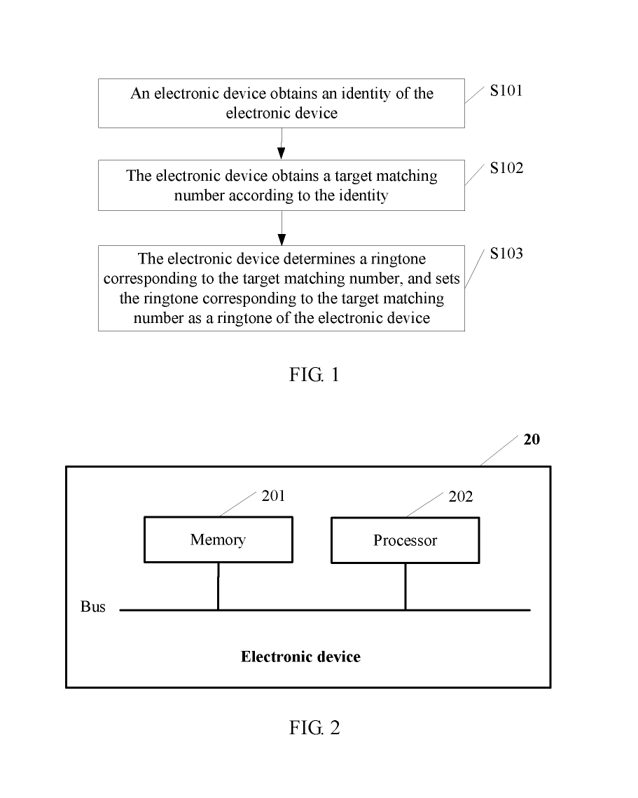

Referring to FIG. 1, FIG. 1 is a schematic flowchart of a ringtone setting method according to an embodiment of the present invention.

Step S101: An electronic device obtains an identity of the electronic device.

Specifically, each electronic device has its own identity, and the identity is used to differentiate the electronic device from other devices. For example, each electronic device has an international mobile equipment identity (International Mobile Equipment Identity, IMEI), a mobile equipment identifier (Mobile Equipment Identifier, MEID), a Media Access Control (Media Access Control, MAC) address, and the like, and all of these may be used as the identity in this embodiment of the present invention. The electronic device may obtain the identity by reading system information of the electronic device. In addition, if the electronic device has a corresponding phone number, the phone number may also be used as the identity, and the electronic device may obtain the identity by scanning (or reading) the phone number. Further, first startup times of electronic devices are usually different. Therefore, a first startup time of the electronic device may also be used as the identity, and the electronic device may obtain the identity by reading information recorded in a system log. Further, each startup time may be used as a new identity. Optionally, a prompt may be sent to a user before a startup time is used as the identity, and, with permission of the user, the new startup time is used as the identity. To sum up, if a probability that a piece of information is the same on two electronic devices is relatively low (for example, lower than a preset probability value), the piece of information may be used as the identity, and the identity can be obtained by the electronic device.

Step S102: The electronic device obtains a target matching number according to the identity.

Optionally, the electronic device performs calculation on the identity by using a preset algorithm, to obtain the target matching number. After the identity is substituted into the preset algorithm, the target matching number can be obtained by means of calculation. Target matching numbers calculated from different identities may be the same. Given that a probability that the target matching numbers calculated from different identities are the same and electronic devices corresponding to the different identities are located in a same area is relatively low, this embodiment of the present invention allows the target matching numbers calculated from different identities to be the same.

In an optional solution, the obtaining, by the electronic device, a target matching number according to the identity includes: dividing a value corresponding to the identity by a quantity of ringtone files, and using a generated remainder as the target matching number. The quantity of ringtones may be obtained by scanning a ringtone library of the electronic device, or a value of the quantity of ringtones may be read from a related system file. For example, if the identity is a phone number 17000000000, and the quantity of ringtones is 30, 17000000000/30=566666666 . . . 2, the generated remainder is 2 (the remainder is 0 in an exact division case). Therefore, the obtained target matching number is 2.

In another optional solution, the obtaining, by the electronic device, a target matching number according to the identity includes using a value formed by preset M digits in a value corresponding to the identity as the target matching number, where M is a positive integer greater than or equal to 1. For example, if the identity is a phone number 17012345678, and the M digits are preset fourth and fifth digits, the formed value is 12, that is, the target matching number is 12. If the identity is the phone number 17012345678, and the M digits are preset first and last digits, the formed value is 18, that is, the target matching number is 18. Other manners are not listed herein one by one.

In still another optional solution, the electronic device adds up preset N digits in a value corresponding to the identity to obtain the target matching number, where N is a positive integer greater than or equal to 2. For example, if the identity is a phone number 17012345678, and the preset N digits are preset fourth and fifth digits, it can be learned from the above that the fourth digit is 1 and the fifth digit is 2, and a value obtained from a sum of the fourth digit and the fifth digit is 3, that is, the target matching number is 3. If the identity is the phone number 17012345678, and the preset N digits are preset first and last digits, a value obtained from a sum of the first digit and the last digit is 9, that is, the target matching number is 9. Other manners are not listed herein one by one.

It should be noted that the identity in this embodiment of the present invention may be a number, or a character string of English letters, symbols, digits, and the like. When the identity is a character string, the character string may first be converted to a number, and the obtained number is the value corresponding to the identity. For example, 26 English letters ABCDEFGHIJKLMNOPQRSTUVWXYZ may be converted sequentially and cyclically to 1234567890 1234567890 123456. Certainly, there are still other conversion manners, which are not listed herein one by one. Then a REM operation, an addition operation, or the like is performed on the obtained number in the manner listed above.

Step S103: The electronic device determines a ringtone corresponding to the target matching number, and sets the ringtone corresponding to the target matching number as a ringtone of the electronic device.

Specifically, in a preset correspondence between a matching number and a ringtone, preferably, one matching number is corresponding to one ringtone (a case in which multiple matching numbers are corresponding to a same ringtone is allowed when a quantity of matching numbers is greater than the quantity of ringtones). In an actual application, the matching number may be known as an identifier, a serial number, or the like.

The calculated target matching number is a matching number in the correspondence. The following uses Table 1 to show an example of a correspondence between a matching number and a ringtone.

TABLE 1

| Matching number | Ringtone |
|---|---|
| 0 | Song 1 |
| 1 | Song 2 |
| 2 | Song 3 |
| 3 | Song 4 |
| 4 | Song 5 |

If the calculated target matching number is 2, it can be found according to Table 1 that a ringtone corresponding to the target matching number 2 is “Song 3”. If the calculated target matching number is 4, it can be found according to Table 1 that a ringtone corresponding to the target matching number 4 is “Song 5”.

Further, the electronic device may directly set the ringtone corresponding to the target matching number as the ringtone of the electronic device. Alternatively, the electronic device may first output prompt information to ask a user whether to set the ringtone as the ringtone of the electronic device. If the user enters indication information instructing to set the ringtone as the ringtone of the electronic device, the electronic device sets the ringtone as the ringtone of the electronic device. If the user enters indication information instructing not to set the ringtone as the ringtone of the electronic device, the electronic device may use another preset algorithm to perform calculation on the identity to obtain another target matching number, determines a ringtone again according to the another target matching number, and asks the user whether to set the ringtone as the ringtone of the electronic device.

In an optional solution, after the determining, by the electronic device, a ringtone corresponding to the target matching number, and setting the ringtone corresponding to the target matching number as a ringtone of the electronic device, the method further includes:

detecting, by the electronic device, a ringtone in a surrounding environment, and determining whether the detected ringtone is the same as the ringtone of the electronic device; and if the detected ringtone is the same as the ringtone of the electronic device, changing, by the electronic device, the ringtone of the electronic device.

Specifically, after the electronic device sets the ringtone corresponding to the target matching number as the ringtone of the electronic device, the electronic device may detect, by using an audio input module (for example, a microphone) of the electronic device, audio information of an electronic device in the surrounding environment. If a ringtone that is the same as the ringtone of the electronic device is detected in the surrounding environment, the electronic device changes its ringtone. For example, in the correspondence between a matching number and a ringtone, the electronic device sequentially selects a ringtone next to the current ringtone of the electronic device as a new ringtone. For another example, the electronic device uses another preset algorithm to perform calculation on the identity to obtain another target matching number, and determines a ringtone again according to the another target matching number. For still another example, the electronic device downloads a ringtone from a preset network ringtone library and uses the ringtone as the ringtone of the electronic device. Optionally, the network ringtone library also includes a correspondence between a matching number and a ringtone, but the network ringtone library is different from ringtone resources pre-stored in the electronic device. The electronic device may send a download request including the target matching number to a server (or a cloud server) on which the network ringtone library resides. The server parses out the target matching number, and then sends a ringtone corresponding to the matching number to the electronic device. The electronic device receives the ringtone and sets the ringtone as a new ringtone. Certainly, the electronic device may also notify, in a form of a sound, a text, a pop-up window, or the like, the user that the ringtone has been changed, and inform the user of information about the new ringtone.

In another optional solution, a ringtone instruction may be agreed upon in advance for electronic devices of a same model. The ringtone instruction is used to obtain ringtone information. An electronic device that receives the ringtone instruction sends its ringtone information to an electronic device that sends the ringtone instruction. In this way, the electronic device that sends the ringtone instruction can know whether there is another electronic device around using a same ringtone as the electronic device that sends the ringtone instruction. If there is another electronic device around using the same ringtone, the electronic device that sends the ringtone instruction may choose to change its ringtone.

In still another optional solution, after setting the ringtone, the electronic device may further detect whether the electronic device is connected to a network. If the electronic device is connected to the network, the electronic device may further send its identity (for example, an IMEI) to a preset server on which many ringtones are stored. The server may allocate different ringtones to electronic devices according to identities of the electronic devices, and push the allocated ringtones to the corresponding electronic devices, so that the electronic devices set the ringtones as new ringtones. Further, the ringtones stored on the server may be different from ringtones stored in the electronic device, and therefore, a ringtone allocated by the server is different from a ringtone of another electronic device.

By implementing the method shown in FIG. 1, the electronic device selects, based on its identity, a ringtone from multiple pre-stored ringtones as the ringtone. This lowers a probability that the electronic device and another electronic device of a same model use the same ringtone.

The foregoing details the method of the embodiments of the present invention. For better implementing the foregoing solutions according to the embodiments of the present invention, the following describes related apparatuses of the embodiments of the present invention with reference to FIG. 2 to FIG. 4.

Referring to FIG. 2, FIG. 2 shows an electronic device 20 according to an embodiment of the present invention. The electronic device 20 includes a memory 201 and a processor 202 (there may be one or more processors 202, and one processor is used as an example in FIG. 2). In some embodiments of the present invention, the memory 201 and the processor 202 may be connected by using a bus or in another manner. A connection by using a bus is used as an example in FIG. 2. The memory 201 is configured to store an instruction, and the processor 202 invokes the instruction stored in the memory 201 to perform the following operations:

obtaining an identity of the electronic device;

obtaining a target matching number according to the identity; and

determining a ringtone corresponding to the target matching number, and setting the ringtone corresponding to the target matching number as a ringtone of the electronic device.

The determining, by the processor 202, a ringtone corresponding to the target matching number may specifically be: finding, from a preset correspondence between a matching number and a ringtone, the ringtone corresponding to the target matching number, where the correspondence includes multiple ringtones, and the matching number may be known as an identifier, a serial number, or the like in an actual application. Preferably, the correspondence between a matching number and a ringtone is a one-to-one correspondence, but a solution in which multiple target matching numbers are corresponding to one ringtone is not excluded.

Optionally, after setting the ringtone, the electronic device may further detect whether the electronic device is connected to a network. If the electronic device is connected to the network, the electronic device may further download a new ringtone from the network for manual change by a user. Optionally, after setting the ringtone, the electronic device 20 may further detect whether there is another electronic device using the same ringtone as the electronic device in a surrounding environment. If there is another electronic device using the same ringtone as the electronic device, the electronic device automatically changes the ringtone.

By performing the foregoing operations, the electronic device 20 selects, based on its identity, a ringtone from multiple pre-stored ringtones as the ringtone. This lowers a probability that the electronic device 20 and another electronic device of a same model use the same ringtone.

In an optional solution, the obtaining, by the processor 202, a target matching number according to the identity is specifically: dividing a value corresponding to the identity by a quantity of ringtone files, and using a generated remainder as the target matching number.

In another optional solution, the obtaining, by the processor 202, a target matching number according to the identity is specifically: using a value formed by preset M digits in a value corresponding to the identity as the target matching number; or adding up preset N digits in a value corresponding to the identity to obtain the target matching number, where M is a positive integer greater than or equal to 1, and N is a positive integer greater than or equal to 2.

In still another optional solution, the identity includes at least one of the following: an international mobile equipment identity IMEI, a mobile equipment identifier MEID, a phone number, or a first startup time.

In yet another optional solution, after the processor 202 determines the ringtone corresponding to the target matching number, and sets the ringtone corresponding to the target matching number as the ringtone of the electronic device, the processor 202 is further configured to:

detect a ringtone in a surrounding environment, and determine whether the detected ringtone is the same as the ringtone of the electronic device, where for example, the processor 202 obtains an audio signal in the surrounding environment by using a microphone, and then the processor 202 analyzes the audio signal to determine whether there is a ringtone that is the same as the ringtone of the electronic device; and

if the detected ringtone is the same as the ringtone of the electronic device, change the ringtone of the electronic device.

By performing the foregoing operations, after the electronic device 20 sets the ringtone, if it is detected that there is another electronic device 20 using the ringtone in the surrounding environment, the electronic device 20 changes its ringtone, to avoid user confusion caused by using the same ringtone as the another electronic device 20.

It should be noted that, for implementation of the electronic device 20 shown in FIG. 2, reference may further be made to specific implementations of the method shown in FIG. 1. Details are not described herein again.

According to the embodiment shown in FIG. 2, the electronic device 20 selects, based on its identity, a ringtone from multiple pre-stored ringtones as the ringtone. This lowers the probability that the electronic device 20 and another electronic device of the same model use the same ringtone.

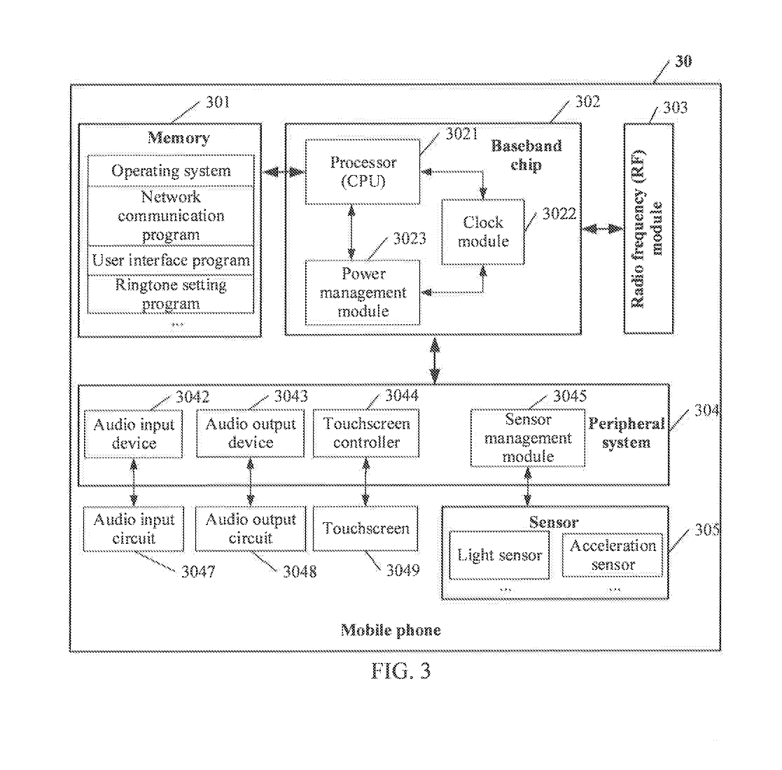

Referring to FIG. 3, FIG. 3 shows a mobile phone 30 according to an embodiment of the present invention. The mobile phone 30 may include at least one memory 301, a baseband chip 302, a radio frequency module 303, a peripheral system 304, and a sensor 305. The memory 301 is configured to store an operating system, a network communication program, a user interface program, a ringtone setting program, and the like. The baseband chip 302 includes at least one processor 3021, such as a CPU, a clock module 3022, and a power management module 3023. The peripheral system 304 includes an audio input device 3042 (for example, a microphone), an audio output device 3043 (for example, a speaker), a touchscreen controller 3044, and a sensor management module 3045, and correspondingly, further includes an audio input circuit 3047, an audio output circuit 3048, and a touchscreen 3049. Further, the sensor 305 may include a light sensor, an acceleration sensor, and the like. In short, the sensor 305 may include more or fewer types of sensors based on an actual need. The memory 301 may be a high-speed RAM memory, or may be a non-volatile memory (non-volatile memory), for example, at least one disk storage. Optionally, the memory 305 may further be at least one storage apparatus located far away from the processor 3021.

The memory 301 may be configured to store an instruction and data. The memory 301 may mainly include an instruction storage area and a data storage area. The instruction storage area may store an operating system, an instruction required by at least one function, and the like. The instruction may enable the processor 3021 to execute the following method. The specific method includes: obtaining an identity of the mobile phone 30; obtaining a target matching number according to the identity; and determining a ringtone corresponding to the target matching number, and setting the ringtone corresponding to the target matching number as a ringtone of the mobile phone 30.

The processor 3021 is a control center of the mobile phone 30, uses various interfaces and lines to connect each part of the entire mobile phone, and executes various functions of the mobile phone 30 and processes data by running or executing a software program and/or a module stored in the memory 301 and invoking data stored in the memory 301, so as to perform overall monitoring on the mobile phone. Optionally, the processor 3021 may include one or more processing units. An application processor mainly processes the operating system, a GUI, an application program, and the like. In this embodiment of the present invention, the processor 3021 is further configured to invoke the instruction and data stored in the memory to implement the following operations: obtaining an identity of the mobile phone 30; obtaining a target matching number according to the identity; and determining a ringtone corresponding to the target matching number, and setting the ringtone corresponding to the target matching number as a ringtone of the mobile phone 30.

The touchscreen 3044 may be configured to display information entered by a user or information provided to the user and various menus of the mobile phone 30. The touchscreen 3044 may include a touch panel and a display panel. Optionally, the display panel may be configured in a form of an LCD (Liquid Crystal Display, liquid crystal display), an OLED (Organic Light-Emitting Diode, organic light-emitting diode), or the like. Further, the touch panel may cover the display panel. After detecting a touch operation on or near the touch panel, the touch panel sends the touch operation to the processor to determine a type of a touch event. Then the processor 3021 provides corresponding visual output on the display panel according to the type of the touch event. The touch panel and the display panel implement input and output functions of the mobile phone 30 as two independent components. However, in some embodiments, the touch panel and the display panel may be integrated to implement the input and output functions of the mobile phone 30.

The audio input circuit 3047, the audio output circuit 3048, the audio output device 3043, and the audio input device 3042 may provide an audio interface between the user and the mobile phone 30. The audio input circuit 3047 may transmit an electrical signal converted from received audio data to the speaker, and the speaker converts the electrical signal to a sound signal for output. In addition, the audio input device 3042 may be configured to detect a ringtone or music in a surrounding environment, convert the detected ringtone or music to an electrical signal, and transmit the electrical signal to the processor.

Further, during a process of setting a ringtone, when the mobile phone 30 needs to output related prompt information to the user, the related prompt information may be output in an audio form by using the audio output device 3043, or output in a video form by using the touchscreen 3049.

Based on a same invention concept, a principle of resolving a problem by the mobile phone is similar to the ringtone setting method in the method embodiment of the present invention. Therefore, for implementation of the mobile phone, reference may be made to implementation of the method, and repetition is omitted herein.

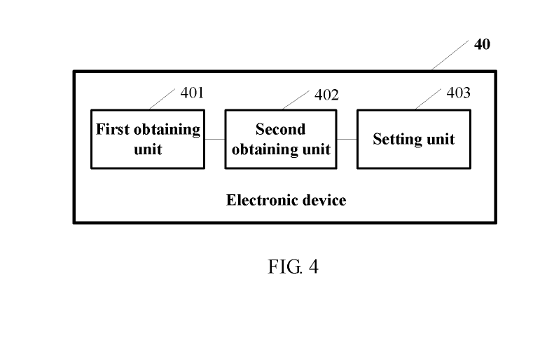

Referring to FIG. 4, FIG. 4 is a schematic structural diagram of an electronic device 40 according to an embodiment of the present invention. The electronic device 40 may include a first obtaining unit 401, a second obtaining unit 402, and a setting unit 403. The units are described in detail as follows.

The first obtaining unit 401 is configured to obtain an identity of the electronic device.

The second obtaining unit 402 is configured to obtain a target matching number according to the identity.

The setting unit 403 is configured to determine a ringtone corresponding to the target matching number, and set the ringtone corresponding to the target matching number as a ringtone of the electronic device.

By running the foregoing units, the electronic device 40 selects, based on its identity, a ringtone from multiple pre-stored ringtones as the ringtone. This lowers a probability that the electronic device 40 and another electronic device of a same model use the same ringtone.

Based on a same invention concept, a principle of resolving a problem by the electronic device is similar to the ringtone setting method in the method embodiment of the present invention. Therefore, for implementation of the electronic device, reference may be made to implementation of the method, and repetition is omitted herein.

It should be noted that, for implementation of the electronic device 40 shown in FIG. 4, reference may further be made to specific implementation of the method embodiment shown in FIG. 1. Details are not described herein again.

By running the foregoing units, after the electronic device 40 sets the ringtone, if it is detected that there is another electronic device 40 using the ringtone in a surrounding environment, the electronic device 40 changes its ringtone, to avoid user confusion caused by using the same ringtone as the another electronic device 40.

Further, a person of ordinary skill in the art may understand that all or some of the processes of the methods in the embodiments may be implemented by a computer program instructing relevant hardware. The program may be stored in a non-volatile (non-transitory) computer readable storage medium. When the program runs, the processes of the methods in the embodiments are performed. The foregoing storage medium includes: any medium that can store program code, such as a ROM, a RAM, a magnetic disk, or an optical disc.

In conclusion, by implementing the embodiments of the present invention, the electronic device selects, based on its identity, a ringtone from multiple pre-stored ringtones as the ringtone. This lowers the probability that the electronic device and another electronic device of the same model use the same ringtone.

What is disclosed above is merely examples of embodiments of the present invention, and certainly is not intended to limit the protection scope of the present invention. A person of ordinary skill in the art may understand that all or some of processes that implement the foregoing embodiments and equivalent modifications made in accordance with the claims of the present invention shall fall within the scope of the present invention.

1.-20. (canceled)

21. A ringtone setting method, applied to an electronic device, comprising:
obtaining, by the electronic device, an identity of the electronic device;
obtaining, by the electronic device, a target matching number according to the identity
determining, by the electronic device, a ringtone corresponding to the target matching number; and
setting, by the electronic device, the ringtone corresponding to the target matching number as a ringtone of the electronic device.

22. The method of claim 21, wherein obtaining the target matching number comprises:
obtaining, by the electronic device, a remainder via dividing a value corresponding to the identity by a quantity of ringtone files; and
setting, by the electronic device, the remainder as the target matching number.

23. The method of claim 21, wherein obtaining the target matching number comprises:
setting, by the electronic device, a value formed by preset M digits in a value corresponding to the identity as the target matching number; or
adding up, by the electronic device, preset N digits in another value corresponding to the identity to obtain the target matching number, the M comprising a positive integer greater than or equal to one, and the N comprising a positive integer greater than or equal to two.

24. The method of claim 21, wherein the identity comprises at least one of an international mobile equipment identity (IMEI), a mobile equipment identifier (MEID), a phone number, or a first startup time.

25. The method of claim 21, wherein after determining the ringtone corresponding to the target matching number and setting the ringtone corresponding to the target matching number as the ringtone of the electronic device, the method further comprises:
detecting, by the electronic device, a ringtone in a surrounding environment;
determining, by the electronic device, whether the detected ringtone is same as the ringtone of the electronic device; and
changing, by the electronic device, the ringtone of the electronic device when the detected ringtone is same as the ringtone of the electronic device.

26. The method of claim 21, further comprising:
outputting, by the electronic device, prompt information indicating setting the ringtone corresponding to the target matching number as the ringtone of the electronic device;
receiving, by the electronic device, indication information instructing to set the ringtone as the ringtone of the electronic device; and
setting, by the electronic device, the ringtone corresponding to the target matching number as the ringtone of the electronic device.

27. The method of claim 21, further comprising outputting prompt information indicating that the ringtone has been changed.

28. An electronic device, comprising:
a memory configured to store an instruction; and
a processor coupled to the memory, the instruction causing the processor to be configured to:
obtain an identity of the electronic device;
obtain a target matching number according to the identity;
determine a ringtone corresponding to the target matching number; and
set the ringtone corresponding to the target matching number as a ringtone of the electronic device.

29. The electronic device of claim 28, wherein in a manner of obtaining the target matching number, the instruction further causes the processor to be configured to:
obtain a remainder via dividing a value corresponding to the identity by a quantity of ringtone files; and
set the remainder as the target matching number.

30. The electronic device of claim 23, wherein in a manner of obtaining the target matching number, the instruction further causes the processor to be configured to:
set a value formed by preset M digits in a value corresponding to the identity as the target matching number; or
add up preset N digits in another value corresponding to the identity to obtain the target matching number, the M comprising a positive integer greater than or equal to one, and the N comprising a positive integer greater than or equal to two.

31. The electronic device of claim 28, wherein the identity comprises at least one of an international mobile equipment identity (IMEI), a mobile equipment identifier (MEID), a phone number, or a first startup time.

32. The electronic device of claim 28, wherein after determining the ringtone corresponding to the target matching number and setting the ringtone corresponding to the target matching number as the ringtone of the electronic device, the instruction further causes the processor to be configured to:
detect a ringtone in a surrounding environment;
determine whether the detected ringtone is same as the ringtone of the electronic device; and
change the ringtone of the electronic device when the detected ringtone is same as the ringtone of the electronic device.

33. The electronic, device of claim 28, wherein the instruction further causes the processor to be configured to:
output prompt information indicating setting the ringtone corresponding to the target matching number as the ringtone of the electronic device;
receive indication information instructing to set the ringtone as the ringtone of the electronic device; and
set the ringtone corresponding to the target matching number as the ringtone of the electronic device.

34. The electronic device of claim 28, wherein the instruction further causes the processor to be configured to output prompt information indicating that the ringtone has been changed.

35. An electronic device, comprising:
a memory comprising instructions; and
a processor coupled to the memory, the instructions causing the processor to be configured to:
obtain an identity of the electronic device;
obtain a target matching number according to the identity;
determine a ringtone corresponding to the target matching number; and
set the ringtone corresponding to the target matching number as a ringtone of the electronic device.

36. The electronic device of claim 35, wherein the instructions further cause the processor to be configured to;
obtain a remainder via dividing a value corresponding to the identity by a quantity of ringtone files; and
set the remainder as the target matching number.

37. The electronic device of claim 35, wherein the instructions further cause the processor to be configured to;
set a value formed by preset M digits in a value corresponding to the identity as the target matching number; or
add up preset N digits in another value corresponding to the identity to obtain the target matching number, the M comprising a positive integer greater than or equal to one, and the N comprising a positive integer greater than or equal to two.

38. The electronic device of claim 35, wherein the identity comprises at least one of an international mobile equipment identity (IMEI), a mobile equipment identifier (MEID), a phone number, or a first startup time.

39. The electronic device of claim 35, the instructions further cause the processor to be configured to:
detect a ringtone in a surrounding environment, and determine whether the detected ringtone is same as the ringtone of the electronic device after determining the ringtone corresponding to the target matching number and setting the ringtone corresponding to the target matching number as the ringtone of the electronic device; and
change the ringtone of the electronic device when the detected ringtone is same as the ringtone of the electronic device.

40. The electronic device of claim 35, the instructions further cause the processor to be configured to output prompt information indicating that the ringtone has been changed.
